(19) United States
(12) Patent Application Publication
(10) Pub. No.: US 2012/0138083 A1
(43) Pub. Date: Jun. 7, 2012

(54) DENTAL FLOSS DEVICE FOR CLEANING TEETH AND NEUTRALIZING BAD BREATH

(76) Inventor: Tai-Cheng Tseng, Kaohsiung (TW)

(21) Appl. No.: 12/959,348

(22) Filed: Dec. 2, 2010

(51) Int. Cl. A61C 15/04

(52) U.S. Cl. 132/323

(57) ABSTRACT

A dental floss device for cleaning teeth and neutralizing bad breath includes a handle; a dental floss holder integrally formed with the handle; and a dental floss held between two opposite ends of the dental floss holder, the dental floss including a protective layer formed thereon. Moreover, the dental floss device further includes either a curved flexible tongue scraping member on a portion of the dental floss holder, the tongue scraping member including a plurality of parallel ridges projecting outward or a flexible tongue scraping member on one surface, the tongue scraping member including two curved equidistant protrusions.

### BACKGROUND OF THE INVENTION

1. Field of Invention

The invention relates to dental floss and more particularly to a dental floss device being capable of both cleaning teeth and neutralizing bad breath.

2. Description of Related Art

Good oral hygiene is essential for preventing tartar build-up which causes problems including cavities, gingivitis, and gum disease. Severe gum disease can cause tooth loss. For promoting oral hygiene, it is done by carefully and frequently brushing with a toothbrush and the use of dental floss to prevent accumulation of plaque on the teeth after food eating.

A typical dental floss is, for example, a plastic ribbon used to remove food and dental plaque form teeth. In use, the floss is gently inserted between the teeth and scraped along the teeth sides.

It is understood that smell can be exhaled from the mouth after eating onions, garlic, etc. This is not desired. However, typical dental floss does not have the function of neutralizing bad breath. Thus, it is desirable of providing a dental floss which is capable of both cleaning teeth and neutralizing bad breath.

### SUMMARY OF THE INVENTION

It is therefore one object of the invention to provide a dental floss device comprising a handle; a dental floss holder integrally formed with the handle; and a dental floss held between two opposite ends of the dental floss holder, the dental floss including a protective layer formed thereon.

The above and other objects, features and advantages of the invention will become apparent from the following detailed description taken with the accompanying drawings.

### BRIEF DESCRIPTION OF THE DRAWINGS

FIG. 1 is a perspective view of a dental floss device according to a first preferred embodiment of the invention where a first configuration of dental floss holder is shown;

FIG. 2 is a perspective view of the dental floss device according to the first preferred embodiment of the invention where a second configuration of dental floss holder is shown;

FIGS. 3A, 3B and 3C are fragmentary views of FIG. 1 where cylindrical, thick flat and thin flat dental flosses are shown respectively;

FIG. 4 is a side elevation of the dental floss device of FIG. 1;

FIG. 5 is a sectional view taken along line A-A of FIG. 4;

FIG. 6 is a perspective view of a dental floss device according to a second preferred embodiment of the invention;

FIG. 7 is an environmental view of the dental floss device of FIG. 6 being used to scrap the tongue in one mode;

FIG. 8 is a perspective view of a dental floss device according to a third preferred embodiment of the invention; and

FIG. 9 is an environmental view of the dental floss device of FIG. 8 being used to scrap the tongue in one mode.

### DETAILED DESCRIPTION OF THE INVENTION

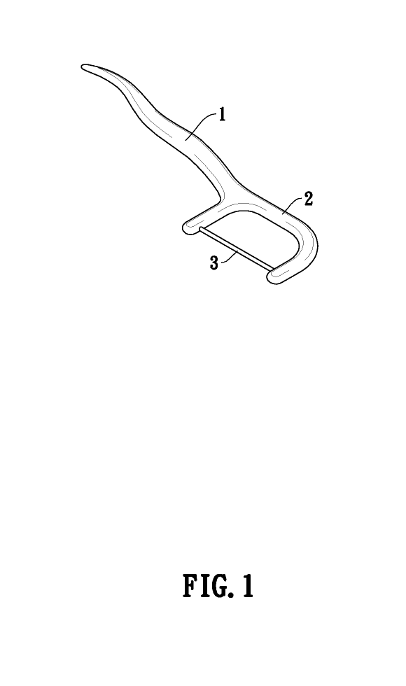

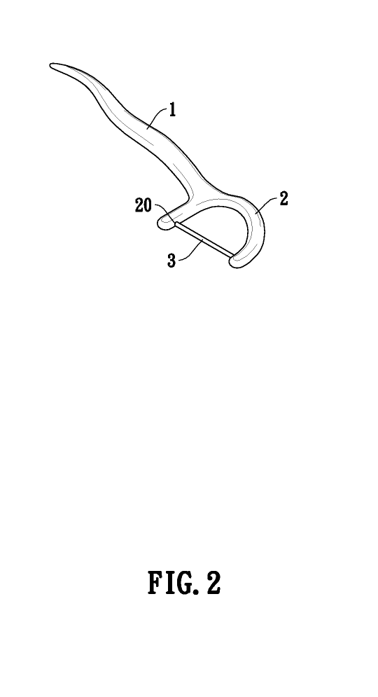

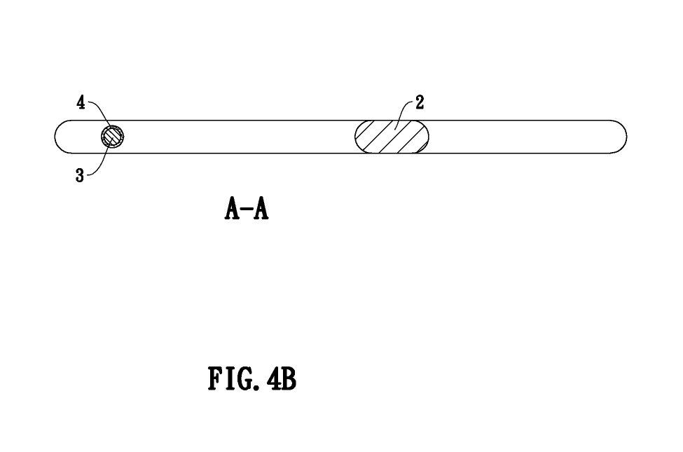

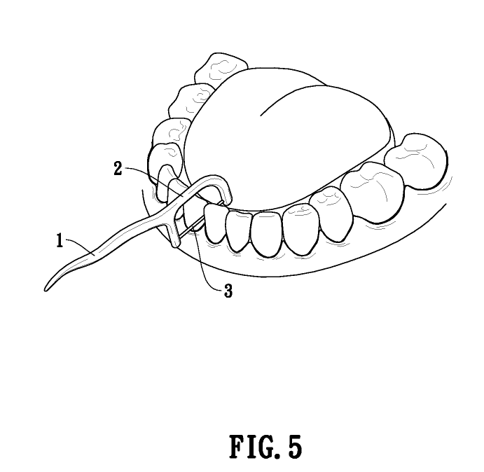

Referring to FIGS. 1 to 5, a dental floss device in accordance with a first preferred embodiment of the invention comprises the following components as discussed in detail below.

A handle 1 is made of molded thermoplastic and is relatively rigid in nature. The handle 1 has a relatively sharp point at an open end. The handle 1 is also ergonomic so that a user may firmly hold the handle 1 to clean teeth and gaps between the teeth for food removal.

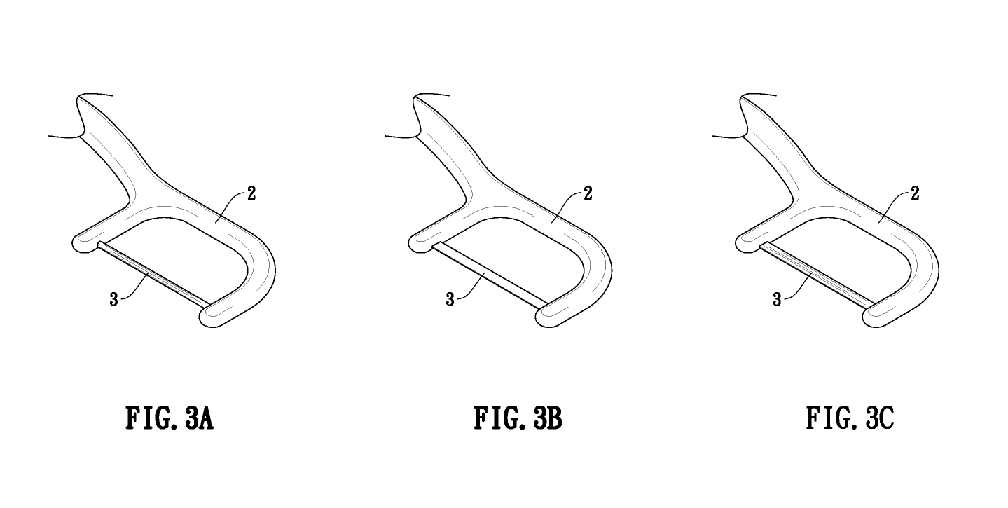

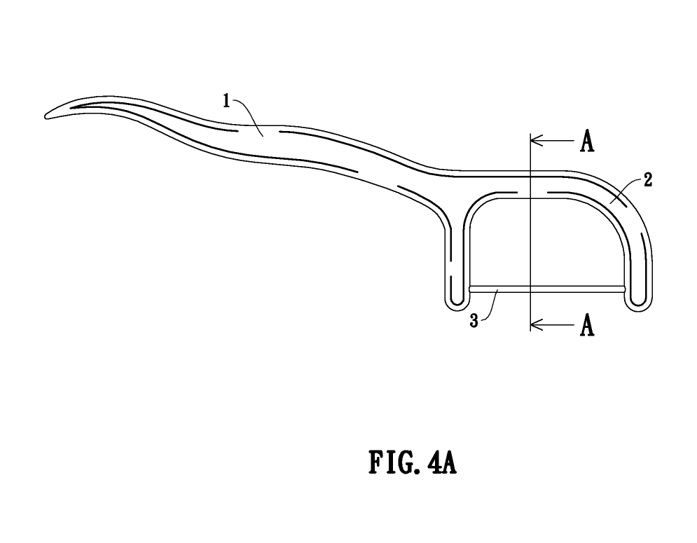

A dental floss holder 2 is integrally formed with the handle 1 and together shape as either an F in a first configuration (see FIG. 1). Alternatively, the dental floss holder 2 is shaped as an arc in a second configuration (see FIG. 3).

A dental floss 3 is held between two opposite ends of the dental floss holder 2. The dental floss 3 is formed of a bundle of thin Teflon® filaments (or synthetic fibers). The dental floss 3 can be shaped as a cylinder (see FIG. 3A), a thick flat member (see FIG. 3B), or a thin flat member (see FIG. 3C). Surface of the dental floss 3 is coated with a protective layer 4 such as fluoride, peppermint, or fruit content. Fluoride can prevent tooth and gum disease. Peppermint has a high menthol content so that the mouth can exhale a flavored breath after using the dental floss 3 having a peppermint based protective layer 4 coated thereon. The fruit (e.g., apple, strawberry, peach, lemon, etc.) flavored protective layer 4 also has the benefit of flavoring the mouth.

Operation of the invention is described in detailed below. The dental floss 3 can be gently inserted between the teeth and scraped along the teeth sides in order to remove food and dental plaque from the teeth (i.e., cleaning teeth). Moreover, the protective layer 4 can help prevent tooth and gum disease if it is made of fluoride. Alternatively, the mouth can exhale a flavored breath if the protective layer 4 is made of peppermint or fruit content (i.e., neutralizing bad breath).

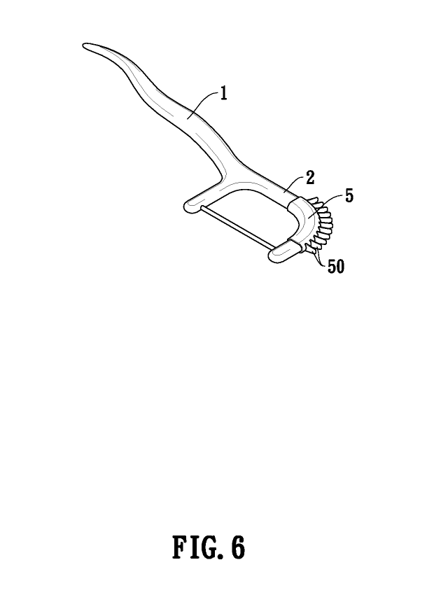

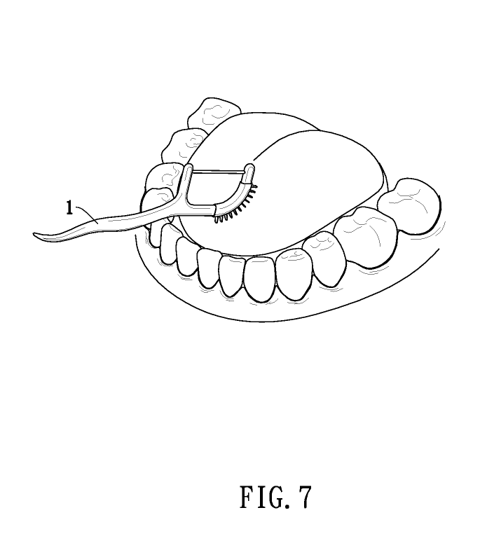

Referring to FIGS. 6 and 7, a dental floss device in accordance with a second preferred embodiment of the invention is shown. The characteristics of the second preferred embodiment are substantially the same as that of the first preferred embodiment except the following: A portion of the dental floss holder 2 is provided with a curved tongue scraping member 5 having a plurality of parallel ridges 50 projecting outward. The tongue scraping member 5 is formed of rubber so as to be flexible.

In use, in addition to cleaning teeth by using the dental floss, a user may hold the handle 1 and repeatedly rub the tongue scraping member 5 on the tongue. Thus, dirt on the tongue is removed by the ridges 50. This has the advantage of neutralizing bad breath.

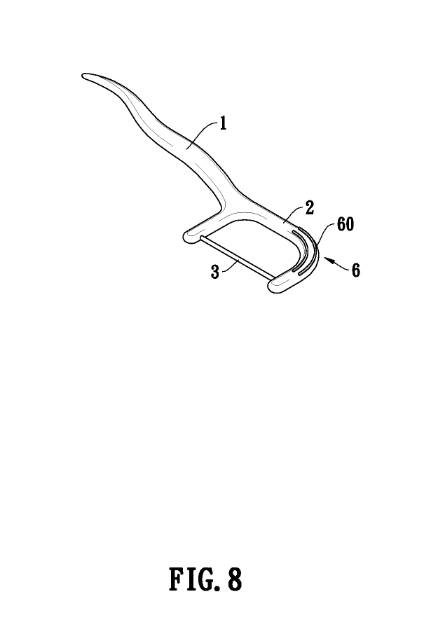

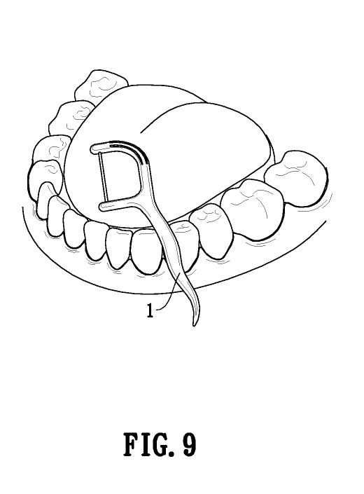

Referring to FIGS. 8 and 9, a dental floss device in accordance with a third preferred embodiment of the invention is shown. The characteristics of the third preferred embodiment are substantially the same as that of the first preferred embodiment except the following: A portion of the dental floss holder 2 is provided with a tongue scraping member 6 having two curved equidistant protrusions 60 on the same surface. The tongue scraping member 6 is formed of rubber so as to be flexible.

In use, in addition to cleaning teeth by using the dental floss, a user may hold the handle 1 and repeatedly rub the tongue scraping member 6 on the tongue. Thus, dirt on the tongue is removed by the protrusions 60. This has the advantage of neutralizing bad breath.

While the invention has been described in terms of preferred embodiments, those skilled in the art will recognize that the invention can be practiced with modifications within the spirit and scope of the appended claims.

What is claimed is:

1. A dental floss device comprising:
a handle;
a dental floss holder integrally formed with the handle; and
a dental floss held between two opposite ends of the dental floss holder, the dental floss including a protective layer formed thereon.

2. The dental floss device of claim 1, wherein the protective layer is formed of fluoride.

3. The dental floss device of claim 1, wherein the protective layer is formed of peppermint

4. The dental floss device of claim 1, wherein the protective layer is formed of fruit content.

5. The dental floss device of claim 1, wherein the dental floss is shaped as a cylinder.

6. The dental floss device of claim 1, wherein the dental floss is shaped as a flat member.

7. The dental floss device of claim 6, wherein the dental floss is shaped as a flat element thinner than the flat member of the dental floss.

8. The dental floss device of claim 1, wherein the handle has a relatively sharp point at an open end opposite the dental floss holder.

9. The dental floss device of claim 1, further comprising a curved flexible tongue scraping member on a portion of the dental floss holder, the tongue scraping member including a plurality of parallel ridges projecting outward.

10. The dental floss device of claim 1, further comprising a flexible tongue scraping member on one surface, the tongue scraping member including two curved equidistant protrusions.
